(19) United States
(12) Patent Application Publication
(10) Pub. No.: US 2003/0031826 A1
(43) Pub. Date: Feb. 13, 2003

(54) Table covering

(76) Inventors: Cristina M. Cleveland, Portland, OR (US); Sarah D. Kelvin, Portland, OR (US); Ryan J. Bren, Beaverton, OR (US); William M. Dieter, Portland, OR (US)

Correspondence Address: IPSOLON LLP, 805 SW BROADWAY, #2740, PORTLAND, OR, 97205, US

(21) Appl. No.: 09/924,068

(22) Filed: Aug. 7, 2001

(51) Int. Cl. B32B 3/06; B32B 3/10

(52) U.S. Cl. 428/99; 428/137

(57) ABSTRACT

A table covering is fabricated from a rectangular sheet of laminated, waterproof material for use outdoors. Each end of the sheet includes a cord securement system for attaching the sheet to a tabletop. The cord system is preferably a shock cord system that allows for independent adjustment of the attachment of the sheet to the tabletop. A length adjustment system allows for variable adjustment in the length of the table covering so that the table covering may be used with tabletops of different sizes.

### FIELD OF THE INVENTION

This invention relates to table coverings such as tablecloths, and more particularly to table coverings especially suited for outdoor use.

### BACKGROUND AND SUMMARY OF THE INVENTION

Table coverings such as common tablecloths are used for many purposes. These include decorative functions, as method for protecting the surface of a table, and as a method for providing a clean surface on which food may be served and eaten. The latter use of table coverings is particularly apt when the table is in an outdoor setting where the table is more likely to be dirty or otherwise unappealing. In the outdoor setting the table covering thus provides a clean and sanitary surface for outdoor dining on a table that may otherwise be dirty.

Outdoor events often call for table coverings. But since the coverings are being used outdoors, it is of obvious advantage to have a table covering that is waterproof and easily cleaned. Furthermore, the table covering must be secured to the table to prevent it from being blown off or blown askew by the wind. Moreover, in many cases it may be undesirable to reach under an table that is located outdoors since the table may be dirty and may have insects and spiders and the like residing beneath the tabletop There is a need, therefore, for a table covering suited to outdoor use that meets these needs and provides other advantages.

The present invention is a table covering that is particularly suited to outdoor use but which may be used with any table in any location. The covering provides a flexible, wipeable, waterproof cover that includes an integral attachment system for securing the covering to the table without having to reach under the table. The method of attaching the covering to a table utilizes an elastic cord with a hook on each end. Each hook is secured to a grommet on a side of the covering and the shock cord extends through a grommet on one end of the sheet. The covering is secured to the table by pulling the center portion of the cord outwardly of the end grommet to apply tension to the shock cords, thus smoothing the table covering against the underlying table. The table covering is released from the tabletop by releasing one or both shock cords. The covering is reversible, allowing for a color choice by providing different colors on each of the opposite surfaces. The table covering is fabricated from a material that will not tear easily or fray on the edges. The covering thus has no hem that might otherwise collect dirt, but rather is made of material that allows a durable, attractive clean-cut edge. An attached utility pouch is included for placement of condiments, plates and the like. The utility pouch is also reversible and easily accessible from either surface of the table covering.

### BRIEF DESCRIPTION OF THE DRAWINGS

The invention will be better understood and its numerous objects and advantages will be more readily apparent by reference to the following detailed description of the invention when taken in conjunction with the following drawings:

FIG. 1 is a top view of a table covering according to the present invention showing in phantom lines the table boards of an underlying tabletop.

FIG. 2 is a top view of the opposite side of the table covering shown in FIG. 1, showing in phantom lines the table boards of an underlying tabletop.

FIG. 3 is a perspective view of the table cover according to the present invention as positioned on a tabletop shown by table boards in phantom lines.

### DETAILED DESCRIPTION OF PREFERRED EMBODIMENTS

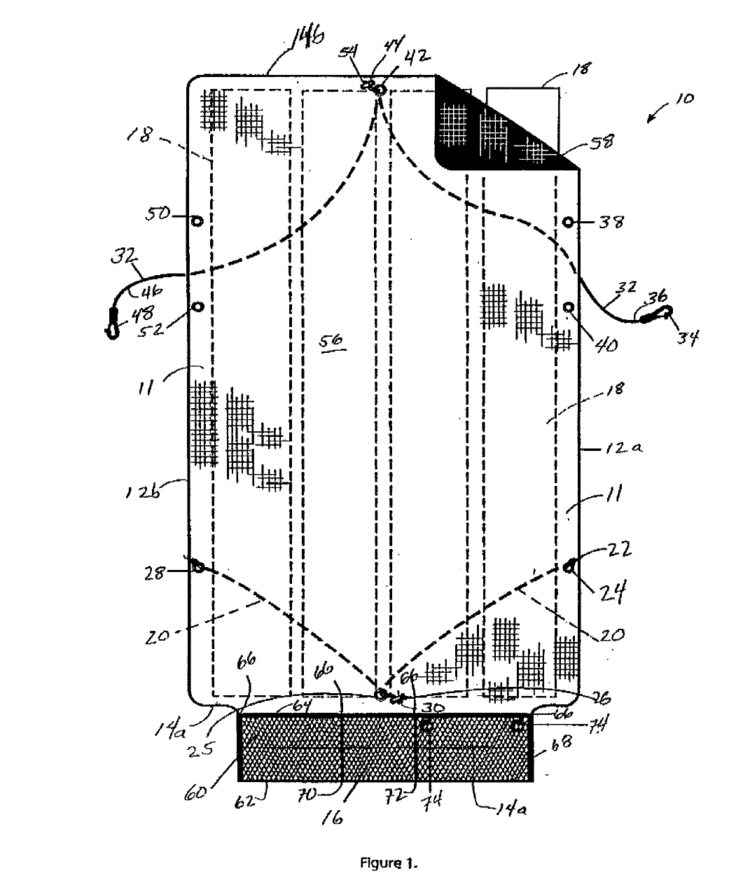

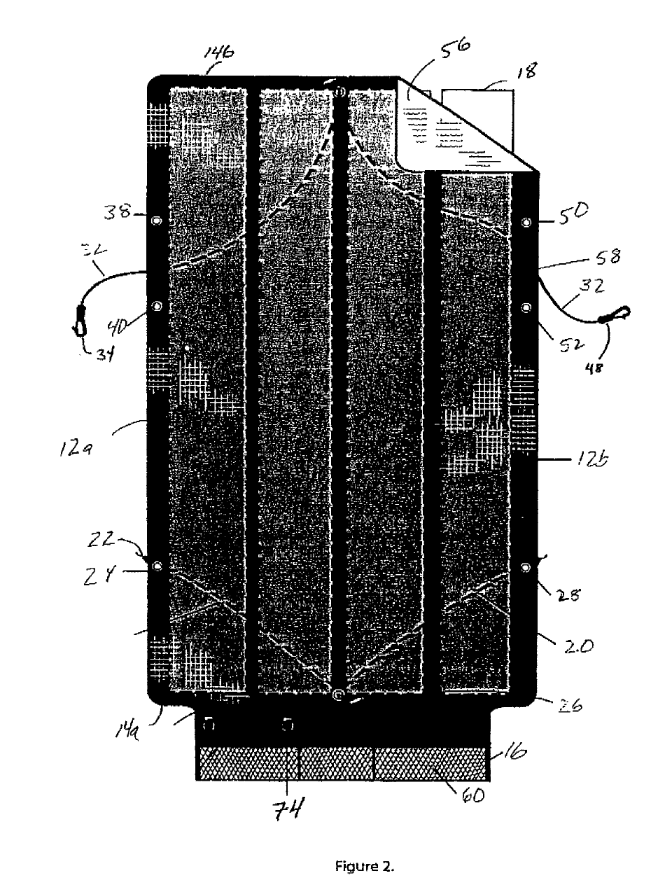

A preferred embodiment of a table covering 10 according to the present invention is illustrated in FIGS. 1 through 3. Although table covering 10 is particularly well suited for outdoor use, the table covering may be just as well be used indoors.

Table covering 10 is fabricated from a sheet 11 of material that is generally rectangular in shape, having opposite side margins or edges 12a, 12b and opposite end margins or edges 14a and 14b. The corners of sheet 11 are shown slightly rounded, although they may be squared off as right angles if desired. A utility pouch 16, described in more detail below, is optionally attached to an end edge 14a. The table covering is sized to cover standard rectangular tables such as picnic tables and the like. A standard picnic tabletop 18 is illustrated schematically in the figures with phantom lines and includes plural table boards that are arranged side-by-side to define the tabletop 18.

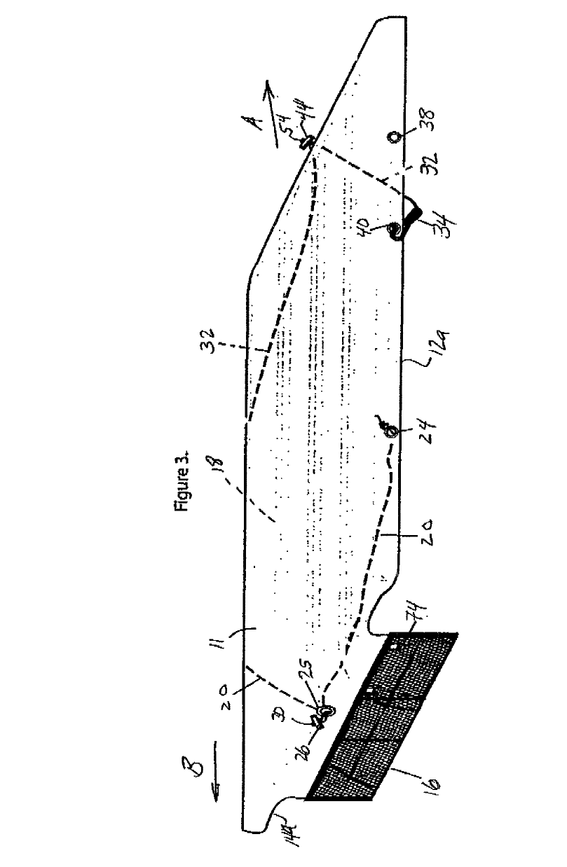

Table covering 10 is connected to the underlying tabletop 18 by means of a dual shock cord system, one shock cord associated with each end edge of the covering. Specifically, with reference to the end edge 14a, a shock cord 20 has a first end 22 connected to sheet 11 near side edge 12a. In the preferred embodiment shown in the figures, first end 22 is attached to side edge 12a at a grommet 24 through which end 22 extends and is knotted. It will be appreciated nonetheless that the end of the shock cord may be attached to the side edge in any convenient manner. Shock cord 20 is doubled over on itself and the doubled-over section extends through a grommet 25 that defines an opening in sheet 11 near end edge 14a. A standard spring-loaded toggle 26 is inserted over the doubled-over section of shock cord 20 and the second end of the shock cord is connected to a grommet 28 near the opposite side edge 12b. A knot 30 is preferably tied in the doubled-over section of shock cord extending beyond toggle 26 to prevent inadvertent removal of the toggle from the cord (FIG. 3).

The opposite end 14b of sheet 11 is fitted with a similar shock cord as that just described. However, this second shock cord is adjustable with respect to its position along side edges 12a and 12b to accommodate use of the table covering with different sized tables. Thus, referring to end edge 14b, a shock cord 32 has a hook 34 connected to the first end 36 of the cord. Hook 34 may be selectively connected to sheet 11 near side edge 12a at a selected grommet 38, 40. Grommets 38 and 40 are positioned along side edge 12a to provide for multiple attachment points for hook 34, depending upon the size of tabletop 18. As described above with respect to shock cord 20, shock cord 32 is doubled over on itself and the doubled-over section extends through a grommet 42 that defines an opening in sheet 11 near end edge 14b. A standard spring-loaded toggle 44 is inserted over the doubled-over section of shock cord 32 outwardly of grommet 42 and the second end 46 of shock cord 32 is fitted with a hook 48 that is connectable to a selected grommet 50 or 52 near the opposite side edge 12b. A knot 54 is preferably tied in the doubled-over section of shock cord extending beyond toggle 44 to prevent inadvertent removal of the toggle from the cord (FIG. 3).

Shock cords 20 and 32 are preferably elastomeric and may be any elastic cord such as bungee cords. Nonetheless, standard cord or rope that is not elastic may be used in place of elastic shock cords.

As noted above, a utility pouch 16 is attached to end edge 14a. Utility pouch 16 is optional, and a pouch may be attached to each end edge or along the side edges as desired. With reference to FIG. 1, pouch 16 is preferably fabricated from a mesh material 60 that will both drain fluids and that will not collect debris. The bottom edge 62 of pouch 16 is closed and gusseted to allow for expansion. The upper edge 64 extends beyond the marginal edge of end edge 14a on both surfaces of the table covering and is attached to table covering 10 at plural attachment points 66, for example by sewing. An outside edge of mesh material 60 is not attached to the table covering material between attachment points 66, thereby defining a top-down opening into the pouch. Binding tape 68 covers the sewn edges of the pouch to provide a clean finish, and plural pouches may be defined by sewing the mesh material at, for example, stitch lines 70 and 72. D-rings 74 are provided to facilitate attachment of other equipment such as knives and the like to the table covering.

Sheet 11 is preferably fabricated from a durable, waterproof and easily cleaned material that may have different colors on the opposite surfaces. For instance, first surface 56 shown in FIG. 1 may be one color, and the opposite second surface 58 (which is shown in one corner of the table covering shown in FIG. 1) may be a different color. The table covering may be reversed. That is, it may be turned over without affecting the performance of the shock cords described above. Further, the material used to fabricate sheet 11 is preferably a material that will not fray along its edges and which is reinforced to prevent tearing. This allows the marginal edges to be unhemmed, as hemming will tend to accumulate dirt. There are numerous materials commercially available that are appropriate for use with the present invention. One such material is an internally reinforced polyethylene laminate that is resistant to tearing and punctures and withstands extended exposure to weather. Reef Industries, Inc. of Houston, Tex., sells this product under the brand name Griffolyn™. There are many other laminates, fabrics and other materials that also work well to make sheet 11.

Table covering 10 is placed over and secured to a tabletop 18 as follows. With reference to FIG. 3, and with hooks 34 and 48 detached from any grommets, sheet 11 is laid over tabletop 18 such that side edges 12a, 12b and end edges 14a, 14b extend beyond the marginal edges of tabletop 18. Shock cords 20 and 32 are positioned such that they extend beneath the lower surface of the tabletop, as shown. Hooks 34 and 48 are then connected to a selected grommet that adjusts the length of sheet 11 to the size most closely approximating the length of the tabletop. Stated otherwise, by varying the position at which the hooks 34 and 48 are connected along the side edges, the length of the table covering—that is, the length of the surface covered—may be adjusted. In FIG. 3 hook 34 is connected to grommet 40 and hook 48 (not shown) is connected to grommet 52. To illustrate the adjustment feature, if tabletop 18 were longer than shown in FIG. 3, hook 34 may be connected to grommet 38 and hook 48 may be connected to grommet 50 to adjust the length of the sheet 11.

With hooks 34 and 48 connected to the appropriate grommets as described, the doubled-over section of cord extending outwardly through opening 42 beyond toggle 44 is pulled outwardly, away from the tabletop, in the direction of arrow A. The cord may be pulled easily by grasping knot 54. As noted above, the shock cords are positioned below the lower surface of the tabletop. Applying tension to the shock cord thus snugs sheet 11 against the tabletop. With the shock cord pulled outwardly, toggle 44 is released and slid toward tabletop 18 along the shock cord until it abuts or lays adjacent grommet 43. The toggle thus acts as a stop to prevent retraction of the cord through the opening, and to thus maintain the tension on the shock cord.

The identical procedure is repeated at the opposite end of the table covering, except that since the first and second ends of the shock cord are fixed to their respective grommets in sheet 11, there is no need to adjust these connections. The doubled-over section of cord extending outwardly beyond toggle 26 is pulled outwardly, away from the tabletop, in the direction of arrow B. The cord may be pulled by grasping knot 30. This applies tension to the shock cord and thus snugs sheet 11 to the tabletop. With the shock cord pulled outwardly, toggle 26 is released and slid toward tabletop 18 along the shock cord until it abuts or lays adjacent grommet 25, again to act as a stop to prevent retraction of the shock cord through the opening and thus maintain the desired tension on the cord.

The shock cords at either end of sheet 11 may then be alternately loosened and/or tightened to adjust the table covering and to secure and smooth it to the tabletop. When attached to the tabletop 18 in this manner sheet 11 provides a smooth and easily cleaned surface. The secure attachment provided by the shock cords prevents the table covering from being blown off or askew by the wind. The table covering may be removed from the tabletop by releasing one or both of the toggles to release tension on the shock cords.

When attached to a tabletop as described above, utility pouch 16 hangs downwardly from end 14a as illustrated in FIG. 3. Utility pouch 16 may be used to store a wide various items such as plates, utensils, napkins, condiments, maps and literature to name a few. Other items may be connected to D-rings 74 as desired.

While the present invention has been described in terms of a preferred embodiment, it will be appreciated by one of ordinary skill that the spirit and scope of the invention is not limited to those embodiments, but extend to the various modifications and equivalents as defined in the appended claims.

We claim:

1. A table covering, comprising:
a sheet of material having opposed side edges and opposed end edges;
a first cord having a first end connected to one side edge, a second end connected to the opposite side edge, and a middle portion between said first and second ends extending through an opening at a first end edge of said sheet material;
a first stop adjustably connected to said first cord outwardly of said opening at said first end edge;
a second cord having a first end releasably connected to one side edge for adjustable positioning of the connection along said one side edge, a second end releasably connected to the opposite side edge for adjustable positioning of the connection along said opposite side edge, and a middle portion between said first and second ends extending through an opening at the second end edge of said sheet; and
a second stop adjustably connected to said second cord outwardly of said opening at said second end edge.

2. The table covering of claim 1 wherein said sheet has a length and the length of said sheet may be varied by selective positioning of the connection of said first and second ends of said second cords along said respective one side and opposite side.

3. The table covering of claim 1 wherein said first cord may be extended outwardly from said opening to apply tension to said first cord.

4. The table covering of claim 3 wherein the position of said first stop on said first cord may be adjusted to prevent retraction of said first cord when said first cord has been extended outwardly from said opening.

5. The table covering of claim 3 wherein said second cord may be extended outwardly from said opening to apply tension to said second cord.

6. The table covering of claim 5 wherein the position of said second stop along said second cord may be adjusted to prevent retraction of said second cord when said second cord has been extended outwardly from said opening.

7. The table covering of claim 1 wherein said sheet is a waterproof material.

8. The table covering of claim 7 wherein said sheet is a multi-layer reinforced laminate.

9. The table covering of claim 1 including at least one pocket connected to one of said edges.

10. The table covering of claim 2 wherein adjustment of said length of said table covering allows said table covering to fit table tops having different lengths.

11. Table covering, comprising:
a generally rectangular sheet of material sized to cover a tabletop having opposed side edges and opposed end edges, said sheet having opposed side edges and opposed end edges that respectively extend beyond said table top side edges and end edges when said sheet is laid on said tabletop;
first means for adjustably securing a first end edge of said sheet to one of said tabletop end edges;
separate second means for adjustably securing the opposite end edge of said sheet to said tabletop, said separate means including means for changing the length of the sheet so that said sheet may be used to cover tabletops of different lengths.

12. Table covering of claim 11 wherein said first means comprises a first cord having a first end connected to one side edge, a second end connected to the opposite side edge, and a middle portion between said first and second ends extending through an opening at a first end edge of said sheet material;
a first stop adjustably connected to said first cord outwardly of said opening at said first end edge.

13. Table covering of claim 11 wherein said second means comprises a second cord having a first end releasably connected to one side edge for adjustable positioning of the connection along said one side edge, a second end releasably connected to the opposite side edge for adjustable positioning of the connection along said opposite side edge, and a middle portion between said first and second ends extending through an opening at the second end edge of said sheet; and
a second stop adjustably connected to said second cord outwardly of said opening at said second end edge.

14. The table covering of claim 11 wherein the length of said sheet may be varied by selective positioning of the connection of said first and second ends of said second cords along said respective one side and opposite side.

15. The table covering of claim 12 wherein said first cord may be extended outwardly from said opening to apply tension to said first cord.

16. The table covering of claim 15 wherein the position of said first stop on said first cord may be adjusted to prevent retraction of said first cord when said first cord has been extended outwardly from said opening.

17. The table covering of claim 13 wherein said second cord may be extended outwardly from said opening to apply tension to said second cord.

18. The table covering of claim 17 wherein the position of said second stop along said second cord may be adjusted to prevent retraction of said second cord when said second cord has been extended outwardly from said opening.

19. The table covering of claim 11 wherein said sheet is a waterproof material.

20. The table covering of claim 19 wherein said sheet is a multi-layer reinforced laminate.
